(19) United States
(12) Patent Application Publication
(10) Pub. No.: US 2013/0159153 A1
(43) Pub. Date: Jun. 20, 2013

(54) Apparatus and methods for energy management system

(71) Applicants: Wai-Kei LAU, Hong Kong (CN); Lap-To Lee, Hong Kong (CN)

(72) Inventors: Wai-Kei LAU, Hong Kong (CN); Lap-To Lee, Hong Kong (CN)

(73) Assignee: Citygrow Energy Systems Ltd.

(21) Appl. No.: 13/326,350

(22) Filed: Dec. 15, 2011

(51) Int. Cl. G06Q 30/04; G06F 1/26

(52) U.S. Cl. 705/34; 700/286

(57) ABSTRACT

Apparatus for providing energy management with automation control features are invented. Power consumption details for building or household can be known as well as the expected power bill in advance. The operation status of specific appliance can also be monitored and controlled. Wireless technology is used as a communication medium with a plurality of appliances which facilitates the management of energy consumption with different applications, like checking the operation status, operating hours and consumption data. An advanced feature of communication with the utility provides power information and instant messaging to users. A consumption target can also be set to economize the electricity bill.

### FIELD OF THE INVENTION

The present invention relates generally to the field of energy management system and more particularly to apparatus and methods to provide energy management features for user to monitor and control power consumption of a plurality of devices and light switches for energy saving purpose.

### BACKGROUND OF THE INVENTION

Energy Management has become a highly prevalent issue in recent years, due to the increasing concerns about the global warming phenomena and its detrimental effects it is causing to our environment. Global warming refers to the increase of the average temperature on Earth, and is largely a result of the increased atmospheric greenhouse gases caused by human activities over the past 20 years. These human activities include the burning of fossil fuels for producing energy such as electricity, but burning fossil fuels is also one of the largest contributors to global warming due to the vast amount of the greenhouse gas CO2 that is produced. The Global warming phenomena is therefore recognized as a continuous issue and actions must be undertaken immediately to counteract the effects.

One of the solutions to counteracting the effects of global warming is to effectively and efficiently manage our already scarce energy resources. An automated energy management system will maximize efficiency and result in the greatest environmental and economic benefits. Installation and maintenance expenses continue to rise in building/home automation, and therefore an automated energy management system must place emphasis on affordability as well as design, flexibility and security.

A wireless approach to an automated energy management has many benefits over wired networks, such as flexibility, lower costs, ease of deployment and also high scalability. Flexibility is one of the greatest benefits, due to the fact that devices in a wireless system can be relocated easily to optimize system performance or adapt to changes in the environment. This results in cost and time saving benefits because there is no re-wiring required for the entire building.

An automated energy management system must monitor energy consumptions of each individual operating device in the system. This will allow the system to see which device is consuming the most energy, and determine whether there are any devices that can be regarded as redundant and wasting energy. One concept of an automated energy management system is for each device in the system to run according to a schedule, where the amount of power supplied to each device is varied depending on On-Peak or Off-Peak times.

### BRIEF SUMMARY OF THE INVENTION

The present invention is directed to the apparatus and methods to provide energy management features in automation system. From a broad sense aspect, the present invention provides wireless enabled gadget with methods to figure out and report the building/apartment electricity consumption based on the recorded consumption data. The capability of communication with the utility facilitates the power bill computation. The energy consumption of the whole system including each device and light switch can also be monitored by user through the user interface of the apparatus. In addition, a number of functions regarding energy management can be provided as well. Scheduling control can also be included in the present invention. The said device and light switch can be applied to a variety of household appliances and lightings as an integrated system.

### BRIEF DESCRIPTION OF THE DRAWINGS

FIG. 1 is a graphical illustration of an energy management system which is to be implemented according to the present invention,

FIG. 2 is a perspective view of the present invention,

FIG. 3A is a preferred embodiment displaying the menu for the power consumption of the system,

FIG. 3B illustrates the display of power consumption details of the system in a graphical representation,

FIG. 3C illustrates the display of power bill details of the system in a graphical representation,

FIG. 4A is a preferred embodiment showing the power consumption details of a specific device in the system,

FIG. 4B illustrates the display of power consumption details for the selected device or light switch in a graphical representation,

FIG. 4C illustrates the display of power bill details for the selected device or light switch in a graphical representation,

FIG. 5 is a preferred embodiment showing the power bill information,

FIG. 6 is a communication flow diagram illustrating the packet flow of the present invention,

FIG. 7 is a preferred embodiment for the present invention to control the on/off status of a particular device or light switch in the system,

FIG. 8 is a preferred embodiment for the present invention displaying the messages from the utility.

### DETAILED DESCRIPTION

The following detailed description of present embodiments refers to the accompanying drawings, which illustrate specific embodiments of the invention. Other embodiments having different structures and operations do not depart from the scope of the present invention. The embodiments described herein are also susceptible to variations, modifications and/or additions other than those specifically described and it is to be understood that the invention includes all such variations, modifications and additions which fall within the spirit and scope of the above description.

Present invention related to the energy management which provides a portable gadget for monitoring and managing a plurality of devices and light switches by using wireless as a communication medium in an energy management system.

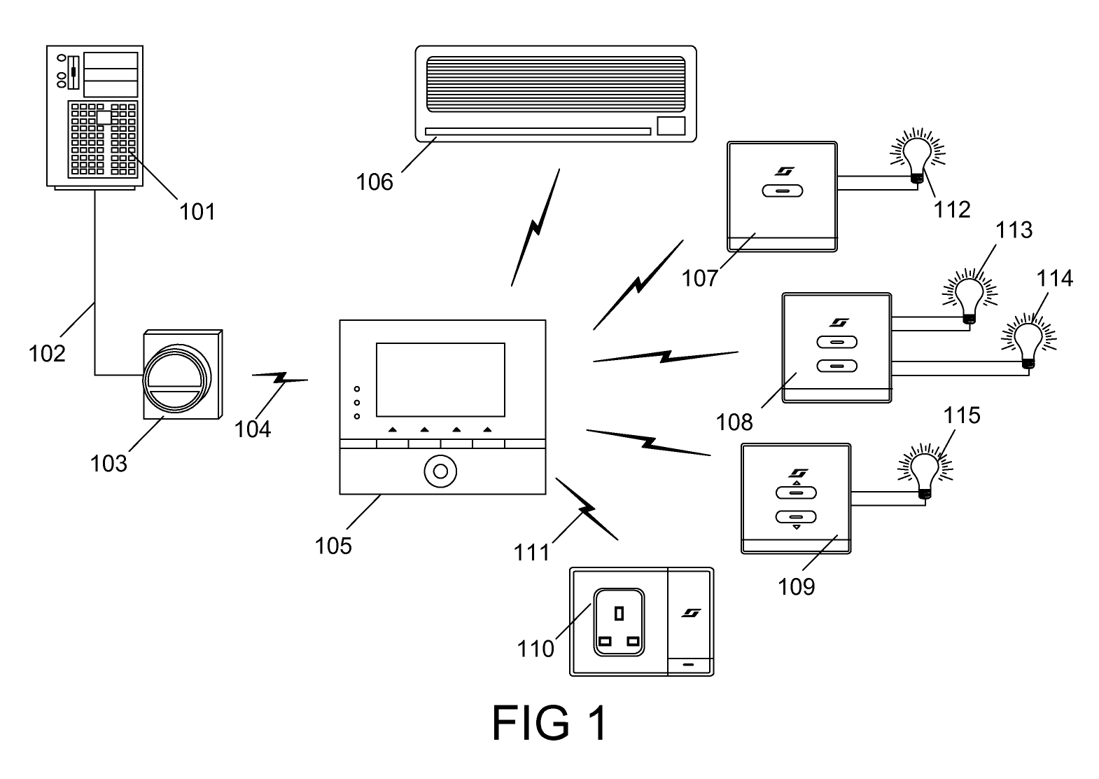

FIG. 1 is a graphical illustration of an energy management system which is to be implemented according to the present invention. An overview of the preferred implementation is shown where a utility server computer 101 may be connected to a utility electricity meter 103 in a building/apartment which is further connected to an energy management system. It is understood that the utility server computer 101 is responsible for all meters 103 in a territory and the communication between utility and users. The data communication between the utility server computer 101 and the meter 103 may be via a private wired network 102 while the data communication between the meter 103 and the energy management system may be via a wireless home area network 104. The energy management system comprises the present invention, a wireless gadget 105, controlling and connecting with a plurality of wireless devices 106, 110 and a plurality of wireless light switches 107, 108, 109 at multiple locations. Examples of the wireless devices may be smart appliance/equipment such as wireless socket 110 where natural electrical appliance can be plugged into the socket for adoption and wireless enabled air-conditioner 106 which further means an appliance may be refitted with a wireless enabled module. It is understood that the device and light switch may be applied to a variety of household appliances and lightings as an integrated system. As for the wireless light switches 107, 108, 109, preferred variations are known to be one-gang light switch 107, two-gang light switch 108 and dimmer 109. The on/off status of lighting 112 can be controlled by the one-gang light switch 107 and the on/off status of lightings 113, 114 can be controlled by the two-gang light switch 108. The luminance of lighting 115 is dimmable by the dimmer 109. For specialty, the electricity consumed details of the devices 106, 110 and light switches 107, 108, 109 can be recorded. Preferred consumption details may comprise power consumed, duration of operation, on/off status, etc. In addition, the operation status of the devices 106, 110 and light switches 107, 108, 109 can be controlled by the gadget 105. Furthermore, scheduling function can be provided based on the operation control function. For managing the devices as a whole, the wireless gadget 105 operates as performing an energy management role for user, data management for environmental conditions, a medium of communication for both users and the utility and a controlling means for the devices. In addition, a database is embedded inside the gadget 105 for storing useful data. Furthermore, humidity and thermostat are embedded inside the gadget for detecting moisture and temperature respectively.

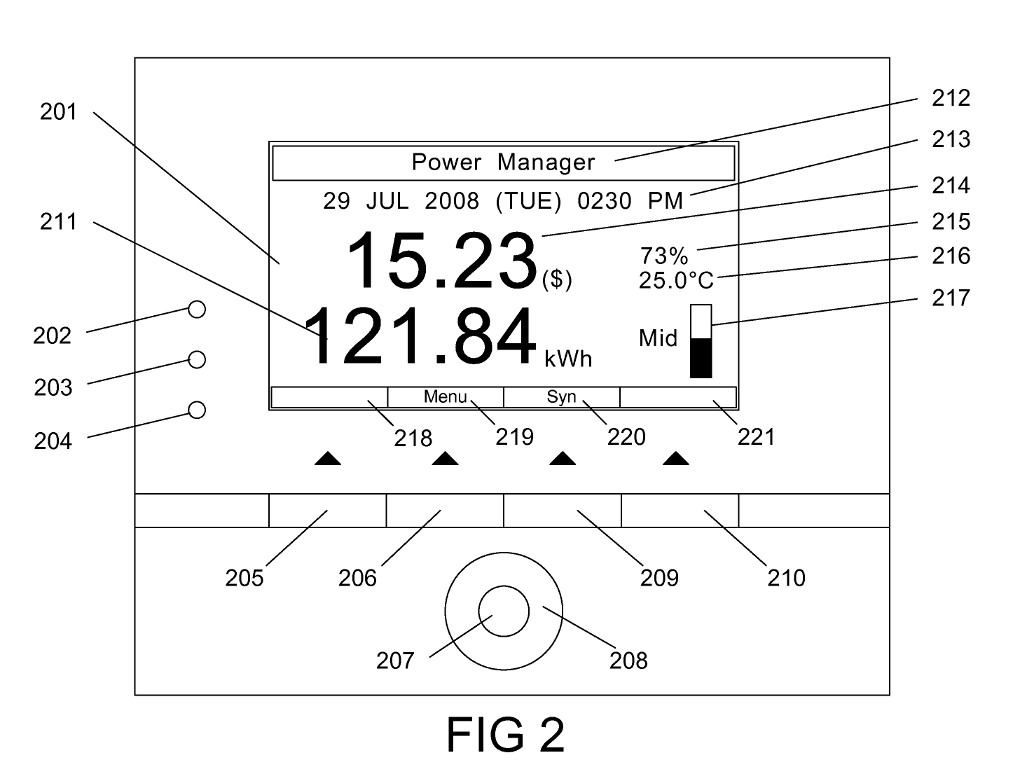

FIG. 2 is a perspective view of the present invention. A LCD monitor 201 is provided for displaying a series of user interface menus for specific operations and two groups of buttons are provided for operation inputs. The group of four rectangular buttons 205, 206, 209, 210 is a set of functioning buttons for each specific menu where the function of each button varies according to the menu. The group of two circular buttons 207, 208 comprises a navigation button 208 and a select button 207 for input selection. In particular, the navigation button 208 comprises four directions: up, down, left and right representing cursor movement. Three indicators 202, 203, 204 will be lit whenever messages, warning or signals are reported to users.

A preferred scenario of a home menu named Power Manager 212 is showcased on the monitor 201 where power management details are shown. Both graphical and text representation are available for the displaying means. The preferred embodiments of the details displayed comprise date and time 213, total power bill 214, total power consumption 211, indoor humidity 215, indoor temperature 216 and energy consumed indicator 217. The object of setting an energy quota is to limit the amount of electricity consumed within a period time. More specifically, the energy consumed indicator 217 is considered as a progress checking with respect to the energy quota set. The energy quota may be a self-defined or utility-defined consumption quota on a daily or a weekly or a monthly or yearly basis. Thus, the higher level of indication, the less energy quota available is left for use. In the preferred menu, the functioning buttons 205, 206, 209, 210 are referred to the functions as shown in the function blocks 218, 219, 220, 221.

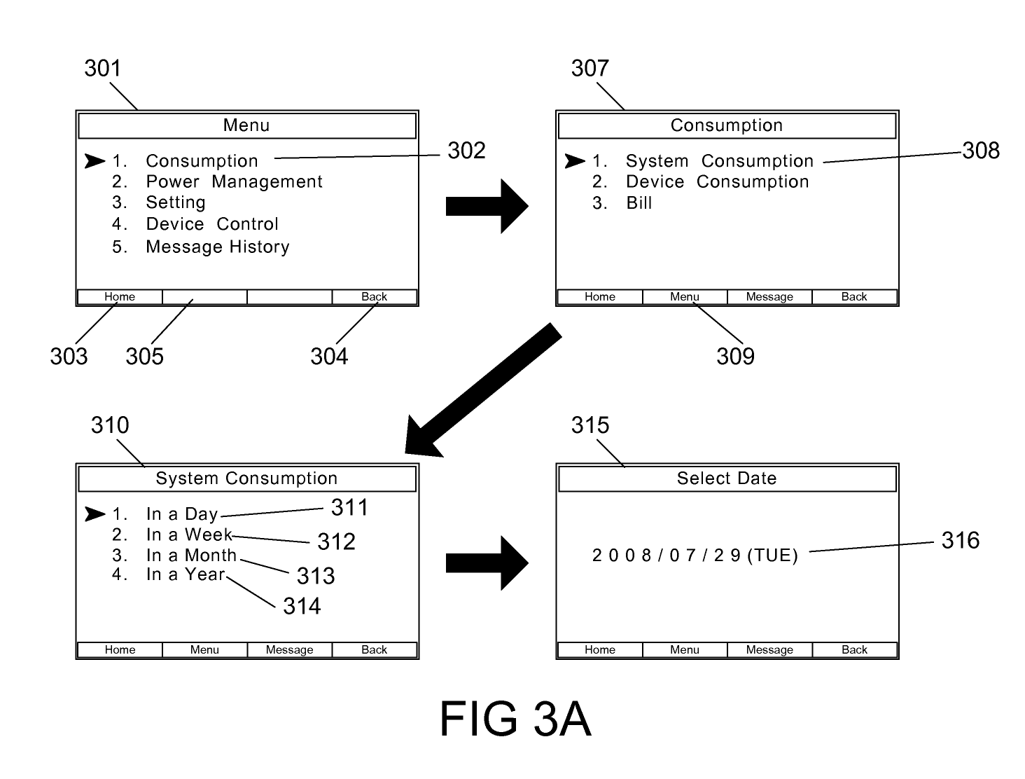

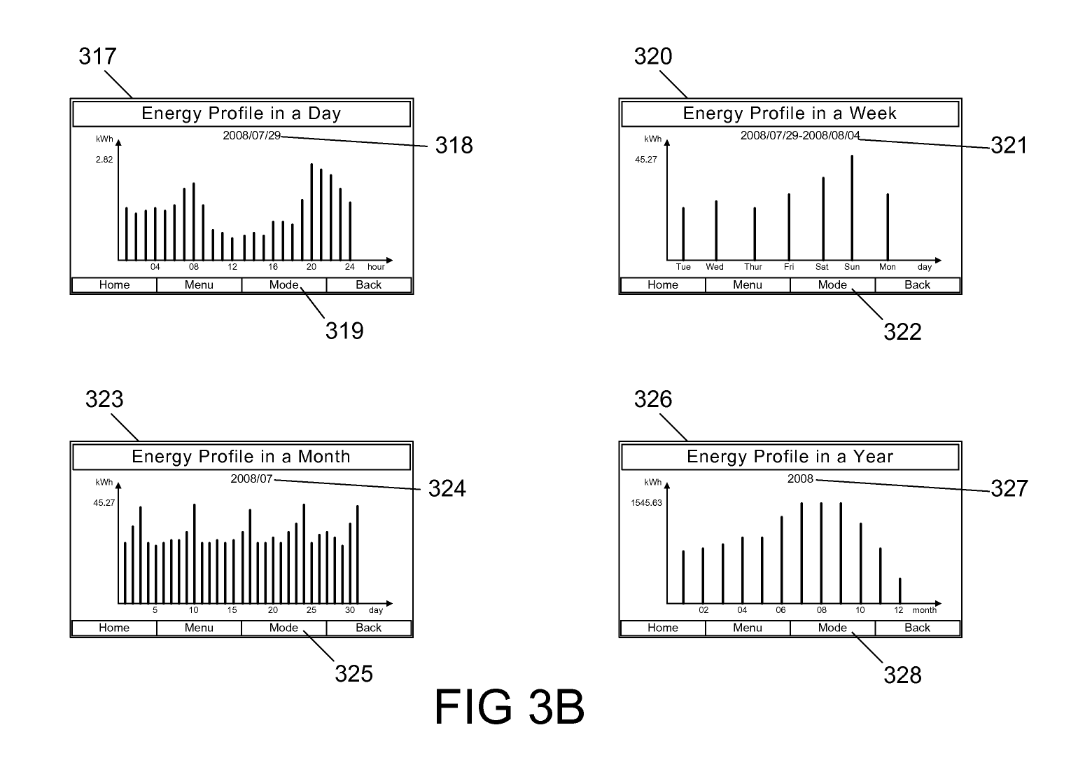

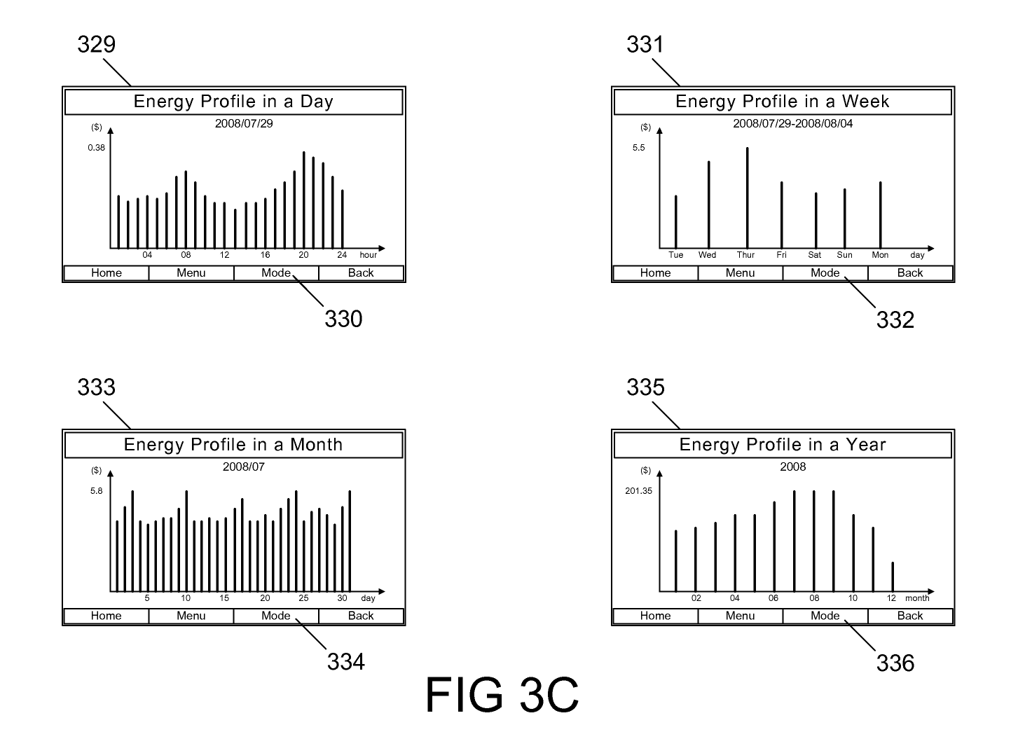

FIG. 3A is a preferred embodiment displaying the menu for the power consumption for the whole system. As shown in the menu selection 301 scenario, multiple menus are available for selection in which a number of functions can be provided upon entering the corresponding menu. The function showcased herein is the display of power consumption details 302 since the wireless gadget is accessible to figure out the power consumption data of either a specific device or the whole system. A preferred text representation is shown for displaying the power consumption checking request. It is shown that the four function blocks bottommost are showing the respective functions in the current menu. Upon clicking the functioning button with respect to home 303, the home menu will be proceeded which can be referred to FIG. 2. Upon clicking the functioning button with respect to back 304, the previously accessed menu will be returned depending on the accessed menu. If there is no other function available, the function block 305 will be left empty as shown.

After the consumption menu 302 is chosen by the confirmation of the selection button, a couple of inquiries are required before power consumption details can be shown. The first inquiry of consumption menu 307 is shown where either the whole system or a specific device can be further selected for reference. In this consumption menu 307, a menu 309 is available in the function block wherein the menu selection 301 scenario can be preceded by clicking the corresponding functioning button. Upon choosing the system consumption selection 308, a further option menu based on the timing reference for the whole system consumption 310 is displayed. The power consumption details can be as detailed as showing in a day 311, week 312, month 313 or year 314. If power consumption in a day 311 is chosen, a further option menu 315 will be displayed for asking a specific date 316. The date 316 shown is amendable by user upon using the navigation and select buttons. Likewise, if a week 312, a month 313 or a year 314 basis is chosen, a corresponding option will be available for amendment.

FIG. 3B illustrates the display of power consumption details for the whole system in a graphical representation. After the inquiries have been finished, a data retrieving and processing is performed. Energy profile in a day 317, week 320, month 323 or a year 326 on the chosen date 318, week 321, month 324 or year 327 can be available. A preferred graphical representation of the energy profile is shown displaying a chart of energy consumed (y-axis) versus every hour in a day (x-axis), every day in a week (x-axis), every day in a month (x-axis) and every month in a year (x-axis). As a user friendly purpose, the switching between the previous or next day can be done by clicking the left or right button respectively. Similarly, the previous or next week, month and year can be clicked in the same way. Upon clicking the up or down button, the switching from a daily profile to weekly profile, a daily profile to monthly profile and a monthly to yearly profile can be done.

Upon clicking the functioning buttons with respect to mode 319, 322, 325, 328, a graphical representation of a chart of power bill (y-axis) versus every hour in a day (x-axis), every day in a week (x-axis), every day in a month (x-axis) and every month in a year (x-axis) can be displayed as shown in FIG. 3C.

When further clicking the functioning buttons with respect to mode 330, 332, 334, 336, the graphical representation of energy profile in FIG. 3B can be returned.

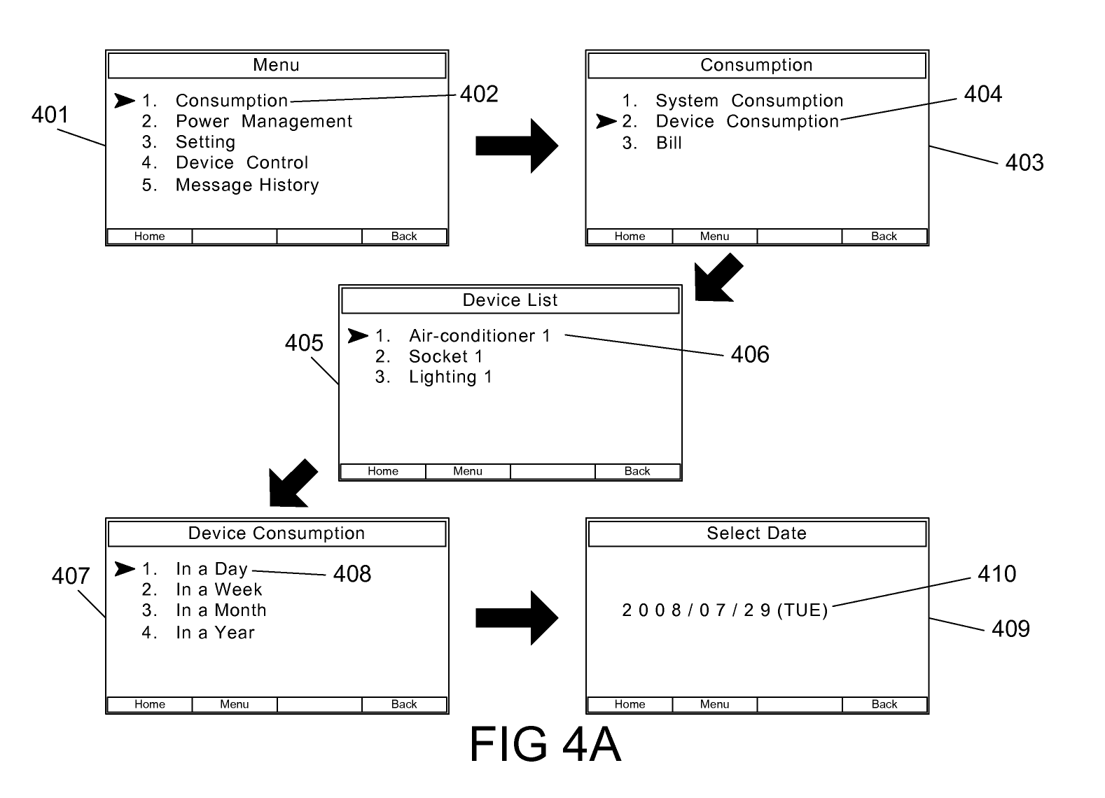

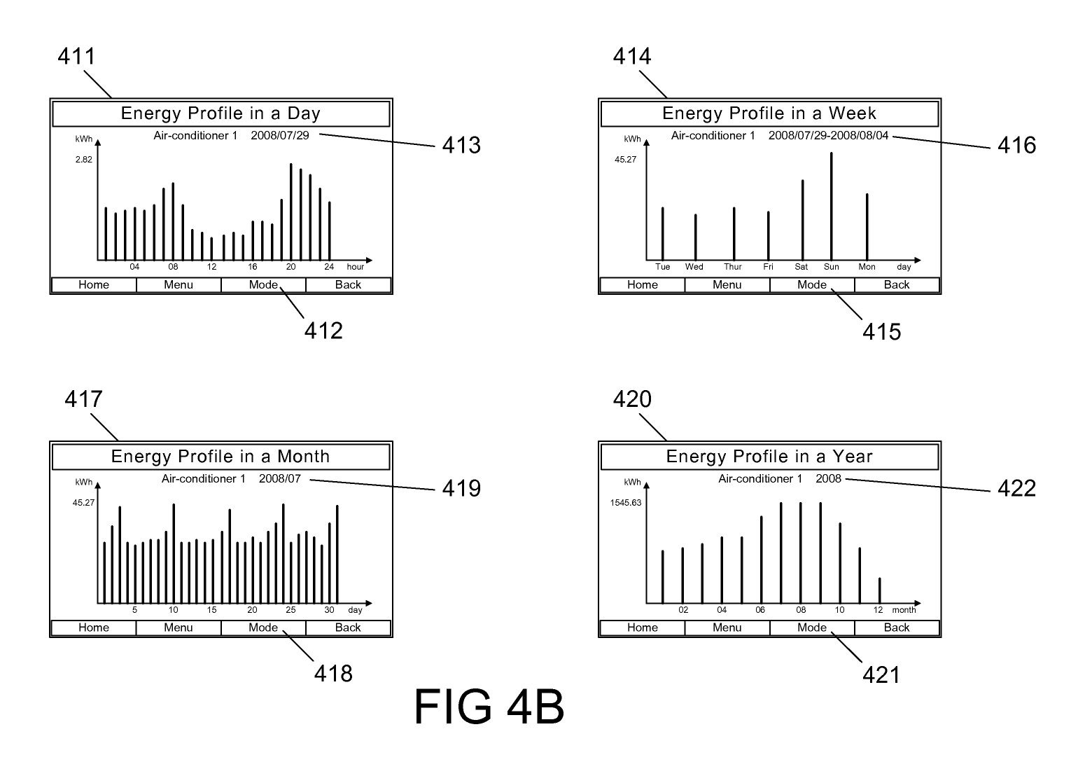

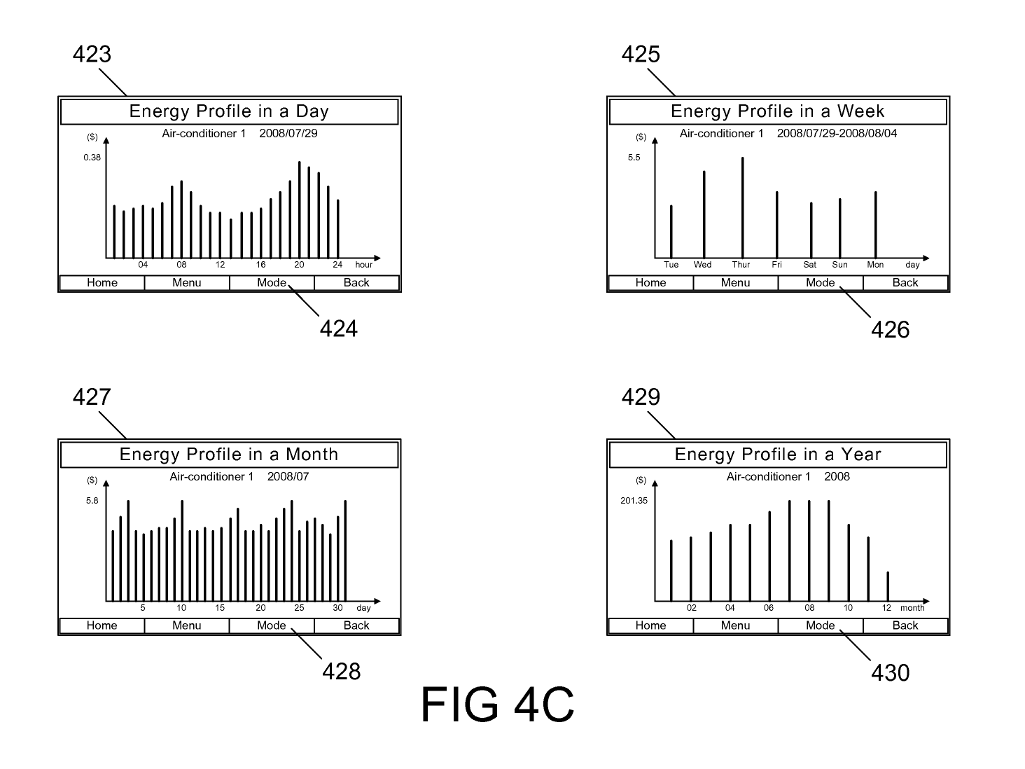

FIG. 4A is a preferred embodiment showing the power consumption details on a specific device in the system. As shown, the device inquiry process is similar to that of the system in which consumption menu 402 is chosen in the main menu 401. It is then followed by choosing the device consumption option 404 in the consumption menu 403. A device list menu 405 is shown where all devices and light switches registered in the system are listed. In the current scenario, air-conditioner 1 406 is chosen for a day 408 in the device consumption menu 407. After a date 410 is chosen in the date selection menu 409, the data retrieving and processing will be performed as shown in FIG. 4B. It is understood that the power bill and power consumption displayed for the specific device or light switch are estimated bill and estimated consumption respectively since no utility approved data is known for a specific device.

FIG. 4B illustrates the display of power consumption details for the selected device or light switch in a graphical representation. After the inquiries have been finished, a data retrieving and processing is performed. Energy profile in a day 411, week 414, month 417 or a year 420 on the chosen date 413, week 416, month 419 or year 422 can be available. A preferred graphical representation of the energy profile is shown displaying a chart of energy consumed (y-axis) versus every hour in a day (x-axis), every day in a week (x-axis), every day in a month (x-axis) and every month in a year (x-axis). As a user friendly purpose, the switching between the previous or next day can be done by clicking the left or right button respectively. Similarly, the previous or next week, month and year can be clicked in the same way. Upon clicking the up or down button, the switching from a daily profile to weekly profile, a daily profile to monthly profile and a monthly to yearly profile can be done.

Upon clicking the functioning buttons with respect to mode 412, 415, 418, 421, a graphical representation of a chart of power bill (y-axis) versus every hour in a day (x-axis), every day in a week (x-axis), every day in a month (x-axis) and every month in a year (x-axis) can be displayed as shown in FIG. 4C.

When further clicking the functioning buttons with respect to mode 424, 426, 428, 430, the graphical representation of energy profile in FIG. 4B can be returned.

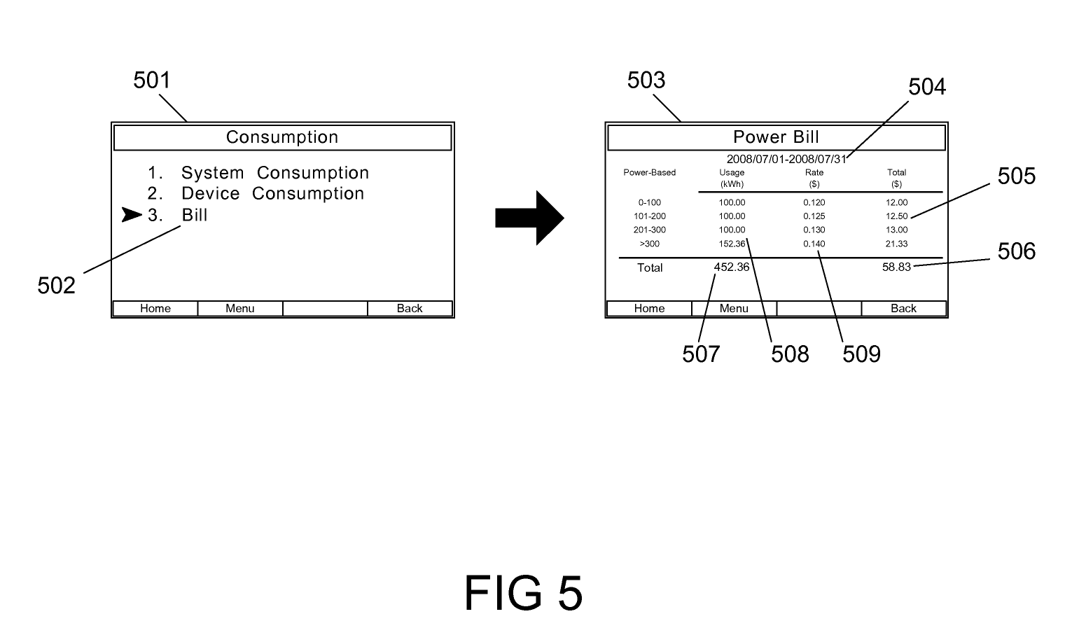

FIG. 5 is a preferred embodiment showing the power bill information. The detailed billing information 502 for user from the utility can be read by selecting the bill option in the power consumption menu 501. As shown, the power bill menu 503 in a specific period of time 504 lists a detailed computation of a user's power bill. The rule of progressive billing method from the utility is demonstrated to user with the multiplication of power usage in kWh 508 with rate in dollar 509 to obtain a set of power based bills 505. A summation of the power usage 507 and total bill 506 will be shown in which users can be budgeted of the expected power bill.

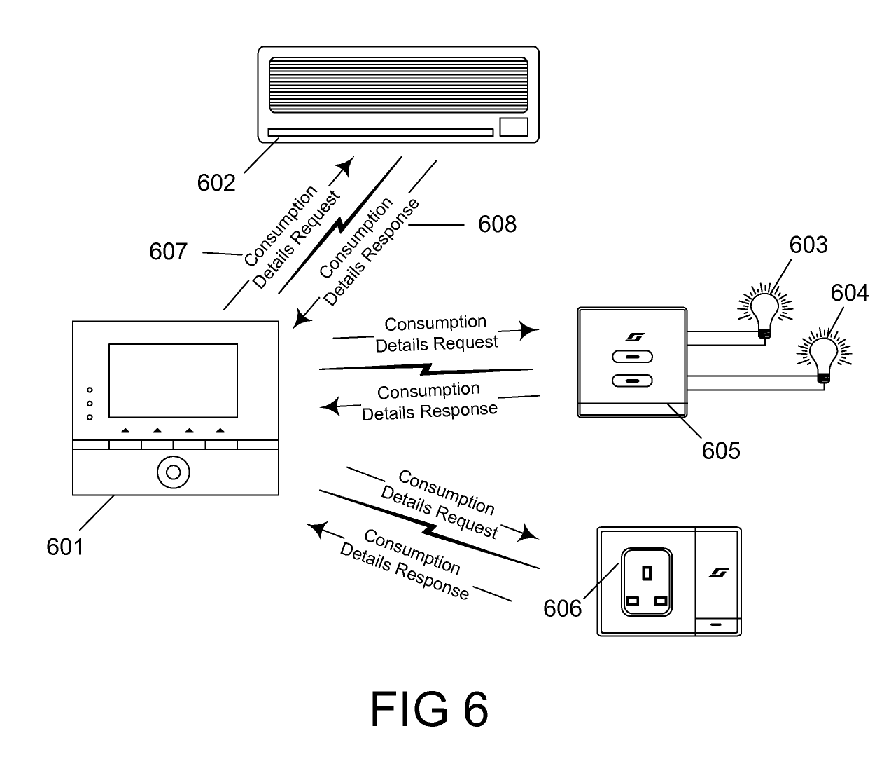

FIG. 6 is a communication flow diagram illustrating the packet flow of the present invention. Periodically, the wireless gadget 601 polls a consumption details request 607 to each of the device and light switch in the system to update the consumption status. As an example, a wireless enabled air-conditioner 602, a two-gang light switch 605 for two individual lightings 603, 604 and a wireless socket 606 are implemented in the system. The aforementioned devices and light switches are capable of recording electricity consumed details. Preferred consumed details may comprise power consumed, duration of operation, on/off status, etc. Thus, upon receiving the polling message of consumption details request 607, a response 608 reporting the consumption details will be replied.

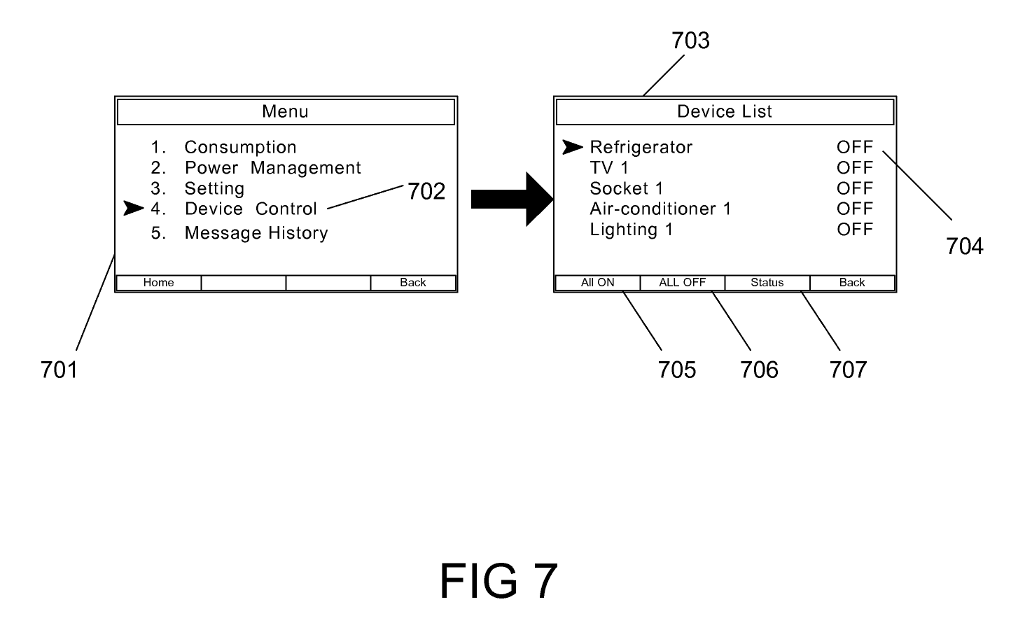

FIG. 7 is a preferred embodiment for the present invention to control the on/off status of a particular device or light switch in the system. In choosing the device control function 702 in the main menu 701, a device list 703 in the whole system is shown listing the devices and light switches with the current operation status in the system. The status of the devices and light switches can be controlled 704 in this preferred embodiment. In this preferred embodiment, some features are provided in the function blocks undermost. Upon using the all ON 705 function, the power supply to all the devices and light switches are permitted which means that all the devices and light switches can be switched on. Upon using the all OFF 706 function, the power supplied to all devices and light switches are blocked which means that all devices and light switches are not possible to switch on. Upon using the status function 707, the current on/off status of individual device and light switch are updated. It is understandable that the device and light switch can be brought under control by the aforementioned features.

Additionally, with the element of timing, a scheduling function can be provided on top of the device control function as well. The operation status of a particular device or light switch in a specified period of time can be set by user. Additional function may be applied to repeated setting for every day or every week. Referring to FIG. 2, the temperature, humidity and energy consumed indicator shown are alternative method of scheduling. For instance, it is understood that air-conditioner consumes a majority of household and building electricity especially in summer, therein conditions can be set for the operation of the air-conditioner. A decision rule on temperature, humidity and energy consumed indicator may be used to determine the suitability of using air-conditioner. As the operation status of the air-conditioner is under control, it is therefore energy efficient to employ decision rule on air-conditioner operation.

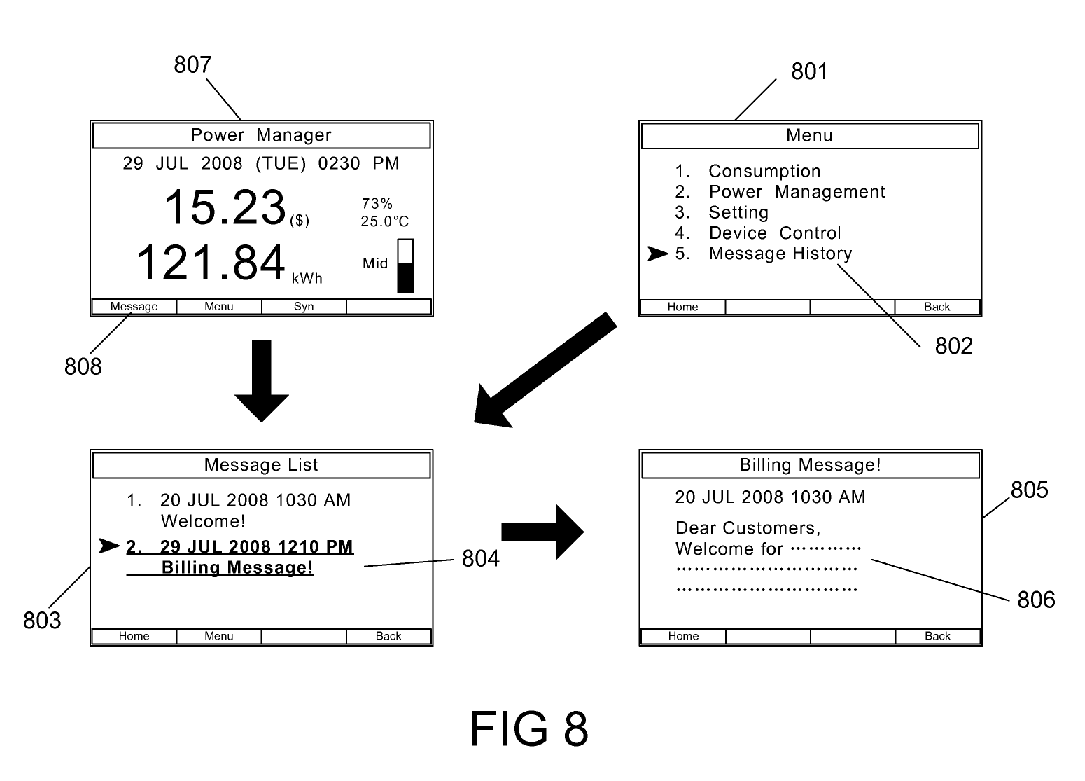

FIG. 8 is a preferred embodiment for the present invention displaying the messages from the utility. In choosing the message history function 802 in the main menu 801, a message list 803 from the utility is shown listing the message received. In the current example, an underlined message is shown which indicates a new message. The cursor also points to the latest unread message by default. When choosing the message topic in the list 804, a full text view of the message 806 can be viewed in the message menu 805. This is an advanced feature where real-time information, such as power failure, expected power bill, service request, can be conveyed to users by this means. Alternative method to access the message list can be done by clicking the functioning button with respect to message 808 in any other menu 807, a message appear in the function block 808 represents at least one unread message is in the message list.

What is claimed is:

1. Apparatus for providing energy management with automation control to a plurality of electrical devices and light switches comprising:
at least one control gadget of embedded wireless module having a displaying means showing a series of user interfaces for operating energy management with automation control features, and data communication with a utility meter;
a plurality of electrical devices and light switches having the capability of recording power consumption, data communication for reporting power consumption and changing the operation status regarding power supply permission.

2. The control gadget of claim 1, further comprising:
at least one sensors embedded for obtaining real-time environmental conditions including temperature, luminance and humidity;
a database storing the said electrical devices and light switches information and power consumption records for displaying power consumption statistics for the system or a particular device or light switch for a period of time.

3. The control gadget of claim 1, wherein the data communication with the utility is enabled with instant messaging and updated power bill information to be received by user.

4. The control gadget of claim 1, wherein the data communication with the utility approved meter is enabled with retrieving the actual power bill to user.

5. The control gadget of claim 1, wherein the data communication with the said plurality of devices and light switches is enabled with a wireless network and is exchanging data periodically.

6. The database of claim 2, wherein the said data can be imported from the gadget to a computer for further processing and storage.

7. The electrical devices and light switches of claim 1, comprising:
wireless enabled sockets in which appliances can be plugged into the socket as an adapter;
wireless enabled extension units in which a couple of appliances can be plugged into the socket as an adapter;
wireless enabled modules embedded in the appliance;
wireless enabled modules embedded in the light switch for controlling at least one lighting.

8. A method of providing energy management, comprising:
collecting and storing the recorded power consumption data in the said database as of claim 2, and displayed by the said displaying mean as of claim 1;
updating and controlling the operation status of the said devices and light switches by user;
scheduling the operation status of the said devices and light switches which can be set by user
reporting the expected monthly or seasonal power bill from utility to

9. The method of claim 8, wherein the recorded power consumption data are as detailed as providing hourly, daily, weekly and monthly data.

10. The method of claim 8, wherein the computation of total power bill is based on the utility approved information including recorded power consumption and bill rate.

11. The method of claim 8, wherein the recorded power consumption data can be referenced to figure out the power bill for all electrical devices and light switches as a whole or individually.

12. The method of claim 8, wherein a consumption target for a specific period of time can be set by user as a consumption indicator.

13. The method of claim 8, wherein alternative scheduling method can be set according to the temperature and humidity recorded by sensor as of claim 2 and the said consumption indicator.

14. The method of claim 8, wherein the power consumption details recorded in the said devices and light switches are reported to the said control gadget periodically.

15. The displaying means of claim 8, wherein text and graphical representation are available.
